(19) United States
(12) Patent Application Publication
(10) Pub. No.: US 2007/0229769 A1
(43) Pub. Date: Oct. 4, 2007

(54) Adjustable light-modulating device

(75) Inventors: Shu-Chen Chan, Kaohsiung City (TW); Ya-Fang Yeh, Changhua Hsien (TW); Yue-Lun Tsai, Tainan Hsien (TW); Sheng-Hsiung Chan, Hsinchu Hsien (TW); Eade Wang, Taipei Hsien (TW)

Correspondence Address: HAMRE, SCHUMANN, MUELLER & LARSON, P.C., P.O. BOX 2902, MINNEAPOLIS, MN, 55402-0902, US

(73) Assignee: DIGIMEDIA TECHNOLOGY CO., LTD., Taipei Hsien (TW)

(21) Appl. No.: 11/473,728

(22) Filed: Jun. 23, 2006

Related U.S. Application Data
(63) Continuation-in-part of application No. 11/396,480, filed on Apr. 3, 2006.

(51) Int. Cl. G03B 21/00

(52) U.S. Cl. 353/31

(57) ABSTRACT

An adjustable light-modulating device includes: a light valve disposed to receive colored light provided by a color separator of a projection display apparatus, and capable of modulating the colored light; an adjusting mechanism including a fixing frame to be disposed between the light valve and the color separator, and a mounting frame coupled rotatably to the fixing frame; and a securing unit for securing the light valve to the mounting frame. The fixing frame defines a first hole, and has a first periphery surrounding the first hole. The mounting frame defines a second hole registered with the first hole, and has a second periphery surrounding the second hole. The adjusting mechanism further includes a guide projection formed on one of the first and second peripheries and projecting toward and contacting slidably the other one of the first and second peripheries.

### CROSS-REFERENCE TO RELATED APPLICATION

This application is a continuation-in-part (CIP) of U.S. patent application Ser. No. 11/396,480, entitled “ADJUSTABLE LIGHT-MODULATING DEVICE”, filed on Apr. 3, 2006.

### BACKGROUND OF THE INVENTION

1. Field of the Invention

The invention relates to a light-modulating device, more particularly to an adjustable light-modulating device for a projection display apparatus.

2. Description of the Related Art

Projection display apparatus has become a common consumer product in recent years. Optical paths of source light within primary color wavelength ranges, i.e., red, green and blue colored source light, in the projection display apparatus, and optical path of combined modulated image light traveling out of the projection display apparatus are key factors to the quality of images projected by the projection display apparatus. Therefore, adjustments to these optical paths are important in improving the image quality. It is thus required for manufacturers to be able to adjust the location of optical components of the projection display apparatus, such as liquid crystal panels, to desired locations before assembling them together to form the projection display apparatus.

Two conventional methods are available for adjusting the locations of the optical components and for assembling these optical components together to form the projection display apparatus. One conventional method uses a six-axis adjusting device, in addition to adhesives that are cured through exposure to ultraviolet light. The other conventional method utilizes laser welding in addition to the six-axis adjusting device. The “six-axis” refers to linear displacements along three dimension axes—length, width and thickness axes—of the liquid crystal panel, and tilt with respect to these axes. However, the six-axis adjusting device is expensive, large in size, and requires professional maintenance. In addition, thermal expansion coefficients of the adhesives and the optical components having the adhesives applied thereto are usually different, which may arise in inconsistent image quality. Moreover, the time it takes to position optical components to desired locations is long for the method that utilizes laser welding.

Therefore, these two conventional methods for adjusting the locations of the optical components and for assembling these optical components together to form the projection display apparatus are costly and inconvenient. Efforts have been put into improving upon the aforementioned drawbacks. In co-pending U.S. patent application Ser. No. 11/396,480, filed by the applicants on Apr. 3, 2006, there is disclosed an adjustable light-modulating device for a projection display apparatus including a color separator that is capable of providing colored light. The adjustable light-modulating device includes a light valve and an adjusting mechanism. The light valve is disposed to receive the colored light provided by the color separator of the projection display apparatus, and is capable of modulating the colored light. The adjusting mechanism includes a mounting frame to be disposed between the light valve and the color separator, and a securing unit for securing the light valve to the mounting frame such that the light valve is linearly displaceable and tiltable relative to the mounting frame. The entire disclosure of the co-pending U.S. patent application is incorporated herein by reference.

### SUMMARY OF THE INVENTION

Therefore, the object of the present invention is to provide an adjustable light-modulating device for application to a projection display apparatus, and whose manufacturing and assembly processes are simplified, and whose manufacturing cost is reduced.

According to the present invention, there is provided an adjustable light-modulating device for a projection display apparatus including a color separator that is capable of providing colored light. The adjustable light-modulating device includes a light valve, an adjusting mechanism, and a securing unit.

The light valve is disposed to receive the colored light provided by the color separator of the projection display apparatus, and is capable of modulating the colored light.

The adjusting mechanism includes a fixing frame to be disposed between the light valve and the color separator, and a mounting frame coupled rotatably to the fixing frame. The fixing frame defines a first through hole, and is formed with a pair of engaging hooks that are disposed at opposite sides of the fixing frame and that project toward the mounting frame. The mounting frame defines a second through hole that is registered with the first through hole. The mounting frame has opposite lateral parts that engage the engaging hooks of the fixing frame, respectively.

The securing unit secures the light valve to the mounting frame such that the light valve is rotatable with the mounting frame relative to the fixing frame.

The fixing frame has a first periphery that surrounds the first through hole, and the mounting frame has a second periphery that surrounds the second through hole. The adjusting mechanism further includes a guide projection that is formed on one of the first and second peripheries and that projects toward and contacts slidably the other one of the first and second peripheries.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an adjustable light-modulating device according to the present invention, together with lens mounting seats and a color separator of a projection display apparatus;

FIG. 2 is an assembled schematic view of the preferred embodiment when applied to the projection display apparatus;

FIG. 3 is an exploded perspective view of an adjusting mechanism according to the preferred embodiment;

FIG. 4 is a top view of the adjusting mechanism according to the preferred embodiment;

FIG. 5 is an assembled sectional view of the adjusting mechanism according to the preferred embodiment, taken along line V-V in FIG. 4;

FIG. 6 is an assembled schematic view of the preferred embodiment;

FIG. 7 is a top view of the adjusting mechanism similar to FIG. 4, illustrating amounting frame rotated at an angle relative to a fixing frame;

FIG. 8 is an assembled schematic view of the preferred embodiment similar to FIG. 6, illustrating a light valve rotated at an angle relative to the fixing frame;

FIG. 9 is an assembled schematic view of the preferred embodiment, together with lens mounting seats of a different projection display apparatus;

FIG. 10 is an assembled schematic view of the preferred embodiment, together with lens mounting seats of yet another different projection display apparatus; and

FIG. 11 is an assembled schematic view of the preferred embodiment, together with lens mounting seats of still another different projection display apparatus.

### DETAILED DESCRIPTION OF THE PREFERRED EMBODIMENT

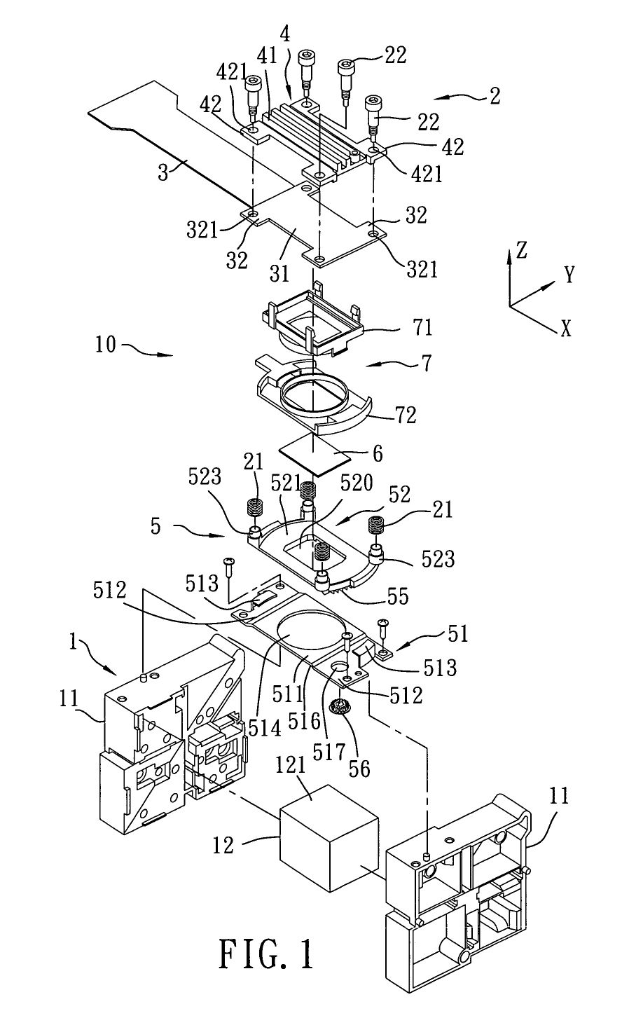

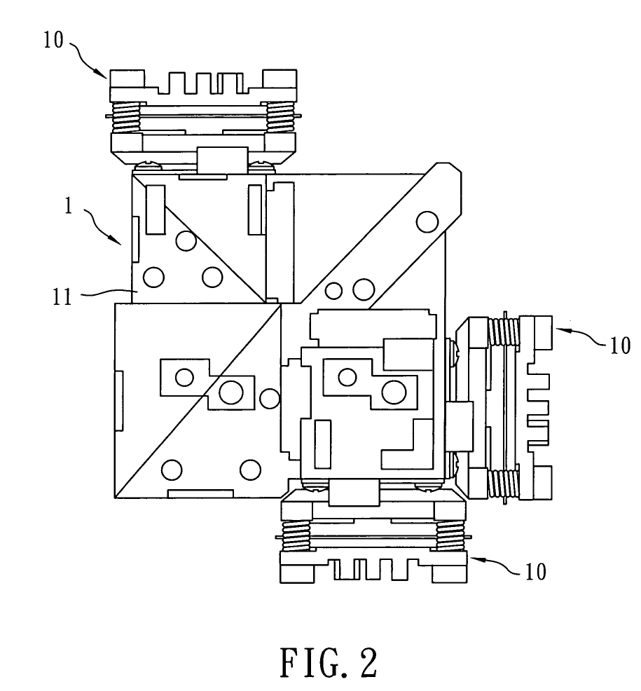

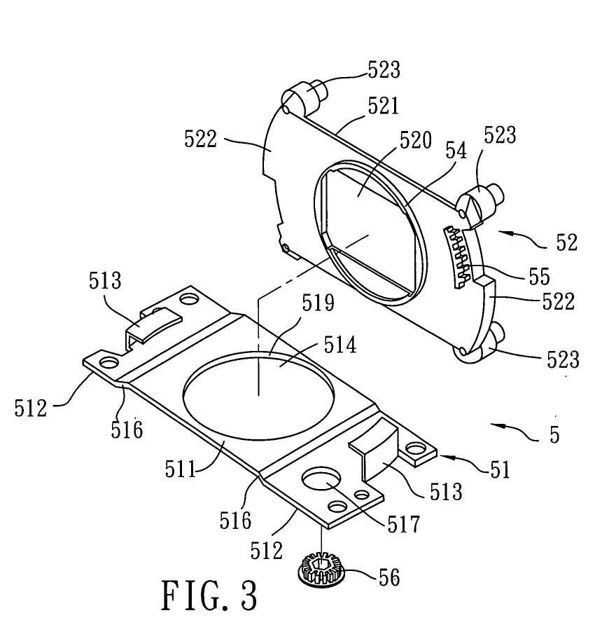

Illustrated in FIG. 1, FIG. 2 and FIG. 3 is the preferred embodiment of three adjustable light-modulating devices 10 according to the present invention that are applied to a projection display apparatus 1. Each of the adjustable light-modulating devices 10 is for modulating a corresponding colored light provided by the projection display apparatus 1, and for adjusting an optical path of the corresponding colored light. Therefore, for a projection display apparatus that only provides two paths of colored light, only two adjustable light-modulating devices 10 will be required. As shown in FIG. 2, the projection display apparatus 1 includes two lens mounting seats 11 (only one is visible in FIG. 2), and a color separator 12 (shown in FIG. 1) clamped between the two lens mounting seats 11. The color separator 12 is capable of providing at least one colored light that travels out of a light-exit side 121 toward a corresponding one of the adjustable light-modulating devices 10.

It is noted herein that only one adjustable light-modulating device 10 is illustrated in FIG. 1. Each of the adjustable light-modulating devices 10 includes a light valve 3, a heat-dissipating member 4, an adjusting mechanism 5, a securing unit 2, a wave plate 6, and a dust protection member 7.

As shown in FIG. 1 and FIG. 3, the light valve 3 is a reflective liquid crystal panel in this embodiment. According to this embodiment, the color separator 12 of the projection display apparatus 1 is capable of providing three colored light, each of which is within a distinct primary color wavelength range. In other words, the color separator 12 is capable of providing red, green and blue colored light. The light valve 3 of each of the adjustable light-modulating devices 10 is disposed to receive one of the three colored light provided by the color separator 12, and is capable of modulating that particular colored light in a conventional manner. The modulated colored light is then reflected by the corresponding light valves 3, and is subsequently combined into image light.

The light valve 3 is spaced apart from the color separator 12, and confronts the corresponding light-exit side 121. The light valve 3 includes a rectangular plate body 31, and four first securing projections 32 extending from the rectangular plate body 31 and disposed at four corners of the rectangular plate body 31, respectively. Each of the first securing projections 32 is formed with a first fastener hole 321.

The heat-dissipating member 4 is disposed on one side of the light valve 3 opposite to the color separator 12, and includes a rectangular heat-dissipating body 41, and four second securing projections 42 extending from the rectangular heat-dissipating body 41 and disposed at four corners of the rectangular heat-dissipating body 41, respectively. Each of the second securing projections 42 is formed with a second fastener hole 421. In particular, the second fastener holes 421 are registered with the first fastener holes 321 in the first securing projections 32 of the light valve 3, respectively.

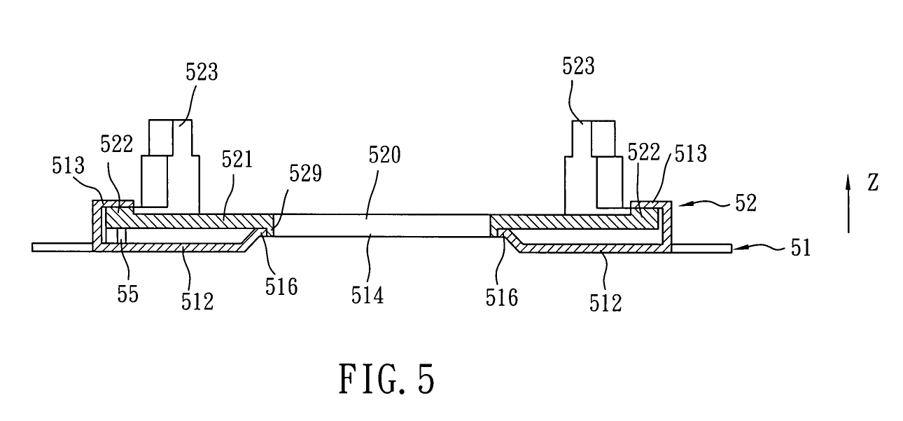

With further reference to FIG. 5, the adjusting mechanism 5 includes a fixing frame 51, a mounting frame 52, a curved rack 55, and a pinion 56.

The fixing frame 51 is disposed between the mounting frame 52 and the color separator 12 of the projection display apparatus 1, and defines a first through hole 514. The fixing frame 51 is formed with a pair of engaging hooks 513 for engaging the mounting frame 52. In this embodiment, the fixing frame 51 includes a central wall part 511 formed with the first through hole 514, and two side wall parts 512 extending from opposite ends of the central wall part 511. Each of the side wall parts 512 forms a shoulder 516 with the central wall part 511. Each of the engaging hooks 513 extends from a respective one of the side wall parts 512 and projects toward the mounting frame 52. A circular gear hole 517 is formed in one of the side wall parts 512 and has the pinion 56 passing rotatably therethrough.

The mounting frame 52 is disposed on the other side of the light valve 3 opposite to the heat-dissipating member 4, is disposed between the light valve 3 and the color separator 12, and defines a second through hole 520. In particular, the mounting frame 52 includes a mounting wall 521 that is formed with the second through hole 520. The second through hole 520 is registered with the first through hole 514. The mounting wall 521 has opposite curved lateral parts 522 that respectively engage the engaging hooks 513 of the fixing frame 51, and that are each formed with a pair of screw sockets 523. In particular, the engaging hooks 513 on the fixing frame 51 engage slidably and respectively the lateral parts 522 of the mounting frame 52 such that the mounting frame 52 is rotatable relative to the fixing frame 51.

In this embodiment, the fixing frame 51 has a periphery 519 (see FIG. 3) that surrounds the first through hole 514. The adjusting mechanism 5 further includes a guide projection 54 (see FIG. 3) that is provided on the mounting frame 52, that surrounds the second through hole 520, and that projects toward and that contacts slidably the periphery 519 to ensure alignment between geometric centers of the first and second through holes 514, 520. In this embodiment, the guide projection 54 is an annular projection that is formed integrally with the mounting frame 52.

The curved rack 55 is provided on the mounting wall 521 of the mounting frame 52, and project toward the fixing frame 51. The pinion 56 is provided rotatably on the fixing frame 51 and meshes with the rack 55 such that rotation of the pinion 56 relative to the fixing frame 51 results in rotation of the mounting frame 52 relative to the fixing frame 51. In particular, the pinion 56 passes rotatably through the gear hole 517 in the fixing frame 51. It should be noted herein that the numbers of racks 55 and pinions 56 are not limited to one in other embodiments of the present invention.

Referring once again to FIG. 1, the securing unit 2 secures the light valve 3 to the mounting frame 52. In particular, the securing unit 2 includes four screw fasteners 22 that pass through the second fastener holes 421 in the heat-dissipating member 4 and the first fastener holes 321 in the light valve 3 and that engage threadedly the screw sockets 523 of the mounting frame 52 such that the heat-dissipating member 4 and the light valve 3 are secured to the mounting frame 52, and four biasing members 21 provided on the mounting frame 52, disposed respectively around the screw fasteners 22, and biasing the light valve 3 away from the mounting frame 52. It is noted that the depth of threaded engagement of each of the screw fasteners 22 with the screw sockets 523 is adjustable so as to adjust at least one of linear displacement and tilt of the light valve 3 relative to the mounting frame 52.

The wave plate 6 is disposed between the mounting frame 52 of the adjusting mechanism 5 and the light valve 3, and is registered with the first through hole 514 in the fixing frame 51 and the second through hole 520 in the mounting frame 52. The dust protection member 7 is disposed between the wave plate 6 and the light valve 3, and is operable to adjust rotatably the position of the wave plate 6 relative to the color separator 12 and the light valve 3. The dust protection member 7 includes a first dust protection frame 71 disposed proximate to the light valve 3, and a second dust protection frame 72 coupled rotatably the first dust protection frame 71. Since the feature of the present invention does not reside in the dust protection member 7, further details of the same are omitted herein for the sake of brevity.

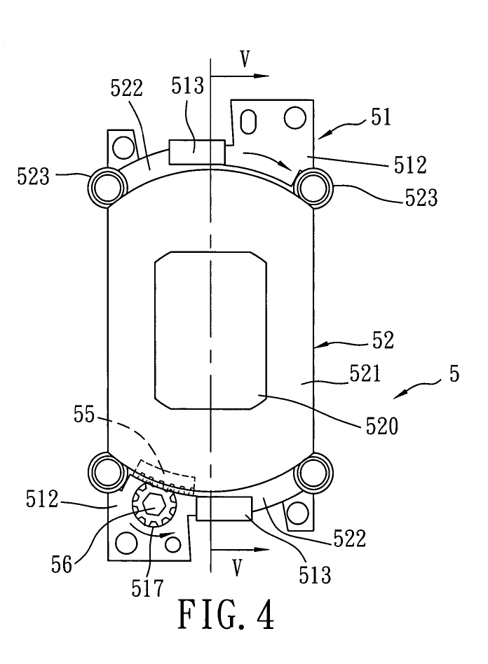

To assemble the adjustable light-modulating device 10, the pinion 56 is first disposed in the gear hole 517. The fixing frame 51, along with the pinion 56, is then disposed on top of the lens mounting seats 11. Subsequently, the mounting wall 521 of the mounting frame 52 is disposed to abut against the fixing frame 51 and the lateral parts 522 of the mounting frame 52 are brought to engage the engaging hooks 513 of the fixing frame 51 such that the mounting frame 52 is rotatable relative to the fixing frame 51. At the same time, the guide projection 54 is disposed in the first through hole 514 and projects toward and contacts slidably the periphery 519, while the pinion 56 meshes with the rack 55, as illustrated in FIG. 4 and FIG. 5.

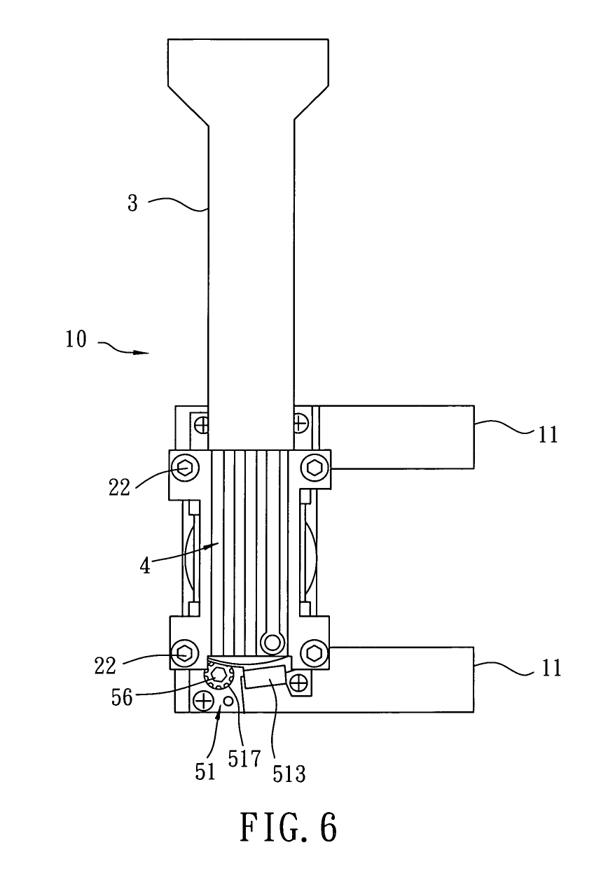

Next, the biasing members 21 of the securing unit 2 are sleeved respectively on the screw sockets 523 at the lateral parts 522 of the mounting frame 52. The wave plate 6, the dust protection member 7, the light valve 3 and the heat-dissipating member 4 are disposed sequentially on top of the mounting frame 52 of the adjusting mechanism 5. The screw fasteners 22 are then extended through the second fastener holes 421 in the heat-dissipating member 4 and the first fastener holes 321 in the light valve 3, and into the screw sockets 523 at the lateral parts 522 of the mounting wall 521 such that the biasing members 21 are disposed respectively around the screw fasteners 22 and such that the heat-dissipating member 4 and the light valve 3 are secured to the mounting frame 52. An assembled schematic view of the adjustable light-modulating device 10 according to this embodiment is shown in FIG. 6.

During use, the colored light traveling out of the corresponding light-exit side 121 of the color separator 12 of the projection display apparatus 1 is projected toward the light valve 3. Control over the location of the light valve 3 on to which the colored light is projected is achieved in the present invention about the axis (Z).

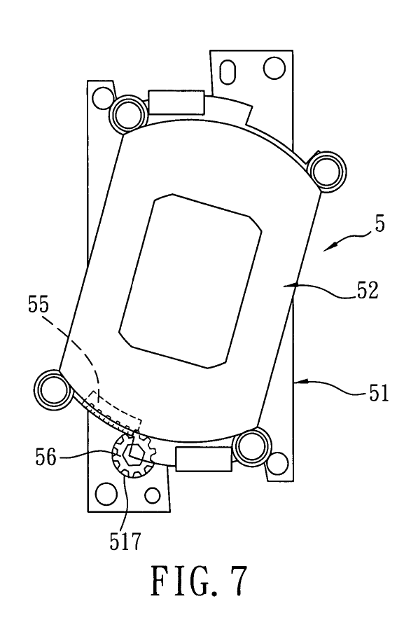

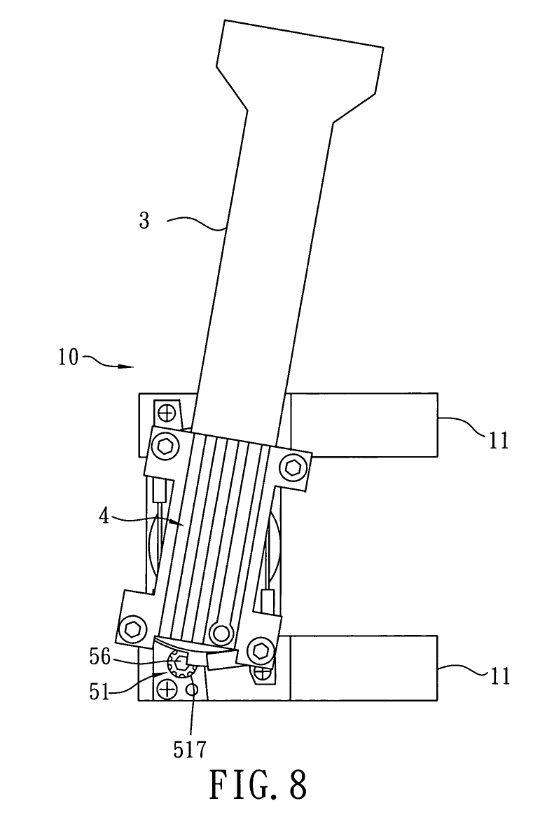

Referring to FIGS. 4, 5 and 6, after the adjustable light-modulating device 10 is assembled, the pinion 56 can drive rotation of the rack 55 about the axis (Z), which results in rotation of the mounting frame 52, such that the location of the light valve 3 is adjusted about the axis (Z). A tool, such as a wrench (not shown), can be used to rotate of the pinion 56 to improve smoothness and angular precision of the rotation of the mounting frame 52. As illustrated in FIG. 7 and FIG. 8, the pinion 56 is rotated until the mounting frame 52, together with the light valve 3, is at an optimal position for projection of the colored light onto the light valve 3.

As shown in FIGS. 1, 3 and 4, since the lateral parts 522 of the mounting frame 52 engage the engaging hooks 513 of the fixing frame 51, wobbling of the mounting frame 52 along the axis (Z) during the rotation of the mounting frame 52 relative to the fixing frame 51 is prevented. In addition, sliding contact between the guide projection 54 and the periphery 519 ensures alignment between geometric centers of the first and second through holes 514, 520 in the fixing and mounting frames 51, 52.

In sum, by including the pinion 56 and the rack 55, and by securing the light valve 3 on the mounting frame 52, the light valve 3 is rotatable about the axis (Z) relative to the fixing frame 51. The adjustment is performed with ease, and involves lower costs as compared to the prior art.

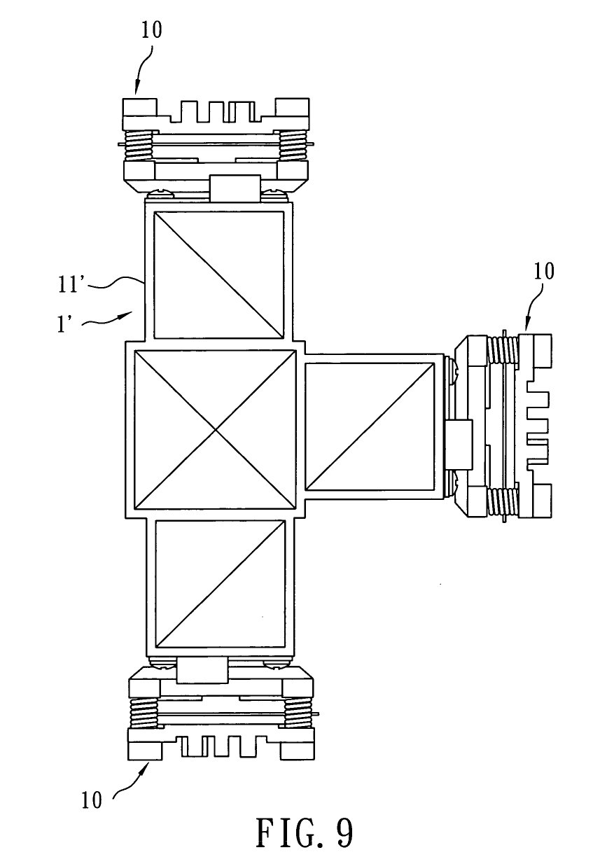

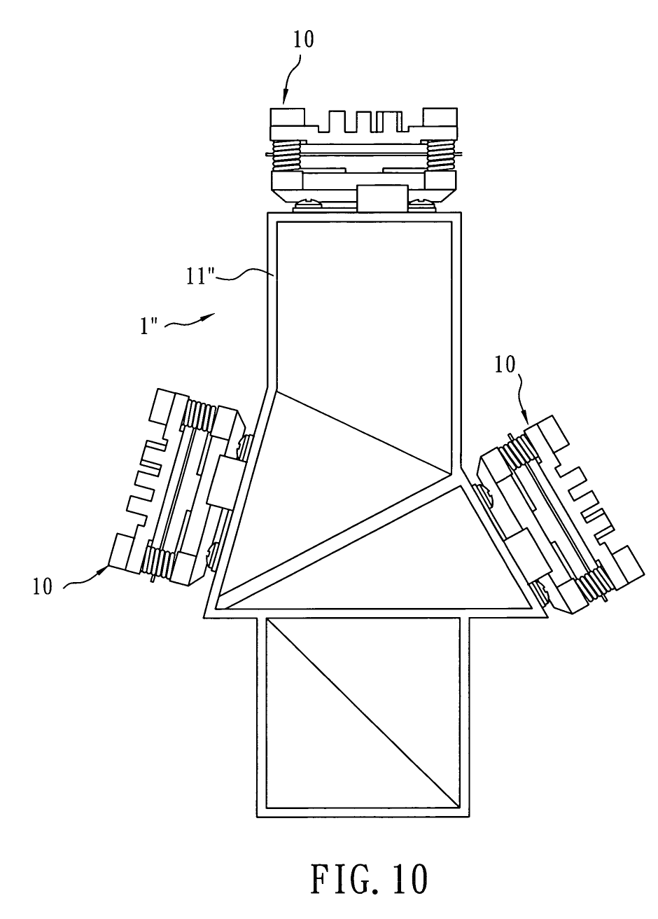

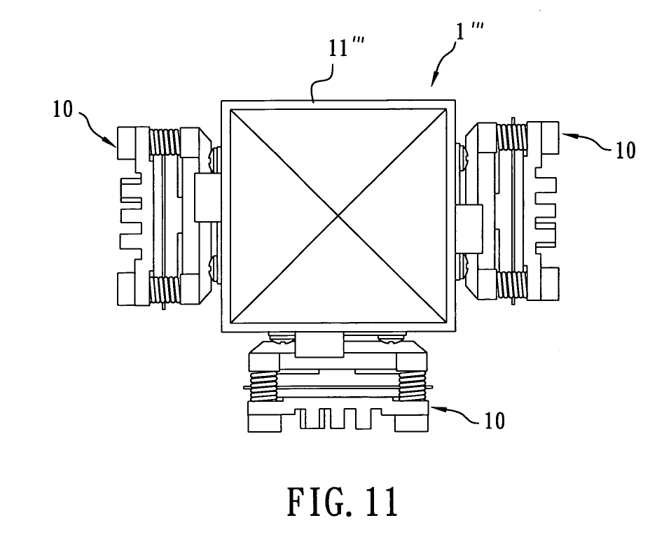

It should be noted herein that the adjustable light-modulating device 10 according to the present invention can also be used with lens mounting seats 11′, 11′, 11′″ of different projection display apparatuses 1′, 1″, 1′″, as illustrated in FIGS. 9, 10 and 11.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An adjustable light-modulating device for a projection display apparatus including a color separator that is capable of providing colored light, said adjustable light-modulating device comprising:
a light valve disposed to receive the colored light provided by the color separator of the projection display apparatus, and capable of modulating the colored light;
an adjusting mechanism including a fixing frame to be disposed between said light valve and the color separator, and a mounting frame coupled rotatably to said fixing frame, said fixing frame defining a first through hole and being formed with a pair of engaging hooks that are disposed at opposite sides of said fixing frame and that project toward said mounting frame, said mounting frame defining a second through hole that is registered with said first through hole, said mounting frame having opposite lateral parts that engage said engaging hooks of said fixing frame, respectively; and
a securing unit for securing said light valve to said mounting frame such that said light valve is rotatable with said mounting frame relative to said fixing frame;
wherein said fixing frame has a first periphery that surrounds said first through hole, said mounting frame having a second periphery that surrounds said second through hole, said adjusting mechanism further including a guide projection that is formed on one of said first and second peripheries and that projects toward and contacts slidably the other one of said first and second peripheries.

2. The adjustable light-modulating device as claimed in claim 1, wherein said guide projection is an annular ring that is formed integrally with said mounting frame.

3. The adjustable light-modulating device as claimed in claim 1, wherein said adjusting mechanism further includes a curved rack provided on said mounting frame and projecting toward said fixing frame, and a pinion provided rotatably on said fixing frame and meshing with said rack such that said rotation of said pinion relative to said fixing frame results in rotation of said mounting frame relative to said fixing frame.

4. The adjustable light-modulating device as claimed in claim 3, wherein said fixing frame has a central wall part formed with said first through hole, and two side wall parts extending from opposite ends of said central wall part, each of said side wall parts forming a shoulder with said central wall part, each of said engaging hooks extending from a respective one of said side wall parts and projecting toward said mounting frame, one of said side wall parts being formed with a gear hole that has said pinion passing rotatably therethrough.

5. The adjustable light-modulating device as claimed in claim 4, wherein said securing unit includes:
four screw fasteners passing through said light valve and engaging threadedly said screw sockets, respectively; and
four biasing members disposed respectively around said screw fasteners, and biasing said light valve away from said mounting frame.

6. The adjustable light-modulating device as claimed in claim 4, further comprising a heat-dissipating member disposed on one side of said light valve opposite to said mounting frame, said screw fasteners further passing through said heat-dissipating member such that said heat-dissipating member and said light valve are secured to said mounting frame.

7. The adjustable light-modulating device as claimed in claim 5, wherein said mounting frame further includes four screw sockets each projecting from a respective one of said lateral ends of said mounting frame toward said light valve.

8. The adjustable light-modulating device as claimed in claim 6, wherein said light valve is a liquid crystal panel.

9. The adjustable light-modulating device as claimed in claim 7, further comprising a wave plate disposed between said mounting frame of said adjusting mechanism and said light valve.

10. The adjustable light-modulating device as claimed in claim 8, further comprising a dust protection member disposed between said wave plate and said light valve, and operable to adjust rotatably position of said wave plate relative to said light valve and the color separator.
